(19) United States
(12) Patent Application Publication
(10) Pub. No.: US 2014/0105094 A1
(43) Pub. Date: Apr. 17, 2014

(54) METHOD AND SYSTEM FOR SECURE ADVERTISEMENTS AND WIRELESS DISCOVERY OF VIRTUAL CONTROLLER BASED ACCESS POINT CLUSTERS

(71) Applicant: Abilash Soundararajan, Bangalore (IN)

(72) Inventor: Abilash Soundararajan, Bangalore (IN)

(21) Appl. No.: 13/654,296

(22) Filed: Oct. 17, 2012

(51) Int. Cl. H04W 4/06

(52) U.S. Cl. 370/312

(57) ABSTRACT

A method for discovering the presence of virtual controller based access point groups using wireless signals. The wireless signals include advertisements which may be secure. Information related to discovered access point groups can be used for merging, over wired or wireless networks, multiple virtual controllers.

### TECHNICAL FIELD

The present disclosure relates to virtual controller based access point groups and advertisements. In particular, the present disclosure relates to discovering virtual controllers. The present disclosure further relates to the broadcasting of encrypted advertisements within beacon frames in accordance with IEEE 802.11 standards.

### BACKGROUND

In recent years, Wireless Local Area Network (WLAN) technologies have emerged as a fast-growing market. Client devices within WLANs communicate with access points to obtain access to one or more network resources. Access points are digital devices that may be communicatively coupled to one or more networks (e.g., Internet, an intranet, etc.). An access point, as referred to herein, may include a wireless access point (WAP) that communicates wirelessly with devices using Wi-Fi, Bluetooth or related standards and that communicates with a wired network.

Typically, access points within a same Internet Protocol (IP) subnet are grouped together into a virtual controller group and are managed by a corresponding virtual controller for the virtual controller group. If no virtual controller exists within the IP subnet, then an election process is used to select one of the access points as the current virtual controller. When a new access point is added to that same IP subnet, the new access point is added to the virtual controller group and managed by the previously selected virtual controller.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present disclosure may be best understood by referring to the following description and accompanying drawings that are used to illustrate embodiments of the present disclosure.

FIGS. 1A-1C illustrate a system in accordance with one or more embodiments;

FIG. 2 illustrates a method in accordance with one or more embodiments;

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in details to avoid obscuring aspects of various examples disclosed herein. It should be understood that this disclosure covers all modifications, equivalents, and alternatives falling within the spirit and scope of the present disclosure.

General Overview

One or more embodiments of the present disclosure relate to discovering and/or helping merge two or more virtual controller groups that are each managed by a corresponding virtual controller, by selecting a single particular virtual controller to manage the two or more virtual controller groups. In accordance with one or more embodiments, isolated virtual controller based Access Point Clusters may discover other such clusters wirelessly and securely without any dependency on wired and routed networks or without establishing any wireless association.

In an embodiment, devices in a first virtual controller group discover devices in a second virtual controller group via one or more devices within the first virtual controller group advertising information. The information may be advertised securely over the air through the Information Element (IE) fields of a beacon frame. In an example, one or more devices within a first virtual controller group advertise a virtual controller group identification that is received by one or more devices in a second virtual controller group. Based at least on the virtual controller group identification, one or more devices in the second virtual controller group initiate communication with one or more devices in the first virtual controller group for merging the second virtual controller group with the first virtual controllers group by selecting a single virtual controller to manage both the set of digital devices in the first virtual controller group and the set of digital devices in the second virtual controller group.

One or more embodiments of the present disclosure relate to discovering access points in the other IP subnets using wireless communication which may include Information Elements transmitted over the air in a wireless signal. An embodiment of the present disclosure relates to selecting a single virtual controller for devices that are distributed over different IP subnets. Devices that are distributed over different IP subnets discover each other using wireless signals and select a single virtual controller for centralized management of the devices that are distributed over different IP subnets.

In one or more embodiment, subsequent to discovery of neighboring digital devices using wireless signals, any method can be used to for selecting a virtual controller or for communication between different IP subnets.

Architectural Overview

A system, in accordance with one or more embodiments, includes multiple digital devices. The term “digital device” generally refers to any hardware device that includes a processor. When the digital device is adapted for communications with a network, the digital device may be configured as a network device, a client device, or both.

A “network device” is a digital device that may be configured to provide a network service. A “client device” is a digital device that may be configured to receive a network service. Examples of digital devices include a computer, a tablet, a laptop, a desktop, a netbook, a server, a web server, authentication server, an authentication-authorization-accounting (AAA) server, a Domain Name System (DNS) server, a Dynamic Host Configuration Protocol (DHCP) server, an Internet Protocol (IP) server, a Virtual Private Network (VPN) server, a network policy server, a mainframe, a television, a content receiver, a set-top box, a video gaming console, a printer, a mobile handset, a smartphone, a personal digital assistant “PDA”, a wireless receiver and/or transmitter, an access point, a base station, a communication management device, a router, a switch, and/or a controller.

In an embodiment, an access point is a network device that comprises one or more of: a hardware processor, data storage, an I/O interface. The hardware processor is communicatively coupled to the data storage and the I/O interface. The processor may be any processing device including, but not limited to a MIPS-class processor, a microprocessor, a digital signal processor, an application specific integrated circuit, a microcontroller, a state machine, or any type of programmable logic array. The data storage of the access point may include a fast read-write memory and a hierarchy of persistent memory such as ROM, EPROM, and Flash memory for storing programs, instructions, and data needed for the operations performed by the access point. The data storage stores data that is to be transmitted from the access point or data that is received by the access point. In an embodiment, the data storage is a distributed set of data storage components.

The I/O interface corresponds to one or more components used for communicating with other devices via wired or wireless segments. The I/O interface may include a wired network interface such as an IEEE 802.3 Ethernet interface and/or a wireless interface such as an IEEE 802.11 WiFi interface. An access point is typically configured for communicatively connecting a client device with one or more resources (e.g., other devices) on a network.

In an embodiment, a digital device comprising a wireless interface (for example, IEEE 802.1 WiFi interface, a Bluetooth interface, or other interface for transmitting or receiving wireless signals) may be referred to herein as a wireless device. Examples of a wireless device include an access point configured to communicate using an IEEE 802.1 WiFi interface, a cellular phone configured to communicate over a cellular network, or a Bluetooth device configured to communicate using Bluetooth signals.

In an embodiment, a virtual controller is a particular digital device that is used to manage a group of digital devices which may or may not include the particular digital device itself. The group of digital devices managed by a virtual controller may be referred to herein as a Virtual Controller Group (VCG). The VCG may include the physical device acting as the virtual controller. The virtual controller is associated with an identifier that can be used to find the virtual controller on a network. In an example, the identifier of the virtual controller can be an IP address, a Media Access Control (MAC) address, an administrator assigned keyword, or any other suitable identifier or any combination thereof.

In one example, a virtual controller is a particular access point that is configured to manage a set of access points. An administrator uses the virtual controller to select attribute values for a set of attributes associated with a set of access points. Management of access points may include, but is not limited to, radio frequency management, network management, security management, authentication management, encryption management, wireless bridging management, wireless backhaul management, VLAN support management, voice-over-Wi-Fi support management, proprietary signal processing management, and/or integrated spectrum analysis management.

In an embodiment, each digital device, in a virtual controller group, is associated with a virtual controller group name corresponding to that virtual controller group. The virtual controller group name is any identifier that is used by digital devices to recognize each other as part of a same group. In an example, devices in a first set of digital devices on a first floor of business building are each assigned a first virtual controller group name “Aruba” by a system administrator. The system administrator assigns a second set of digital devices on a second floor of that business building a second virtual controller group name that is also “Aruba”. When one or more devices within the first set of digital devices determines that one or more devices in the second set of digital devices are associated with the same virtual controller group name (i.e., since both the first virtual controller group name and the second virtual controller group name is “Aruba”), then the first set of digital devices and the second set of digital devices can communicate to initiate selection of a single virtual controller for management of both the first set of digital devices and the second set of digital devices. Accordingly, a system administrator (or other user or other program) can configure different digital devices intended to form the same virtual controller group with a same virtual controller group name.

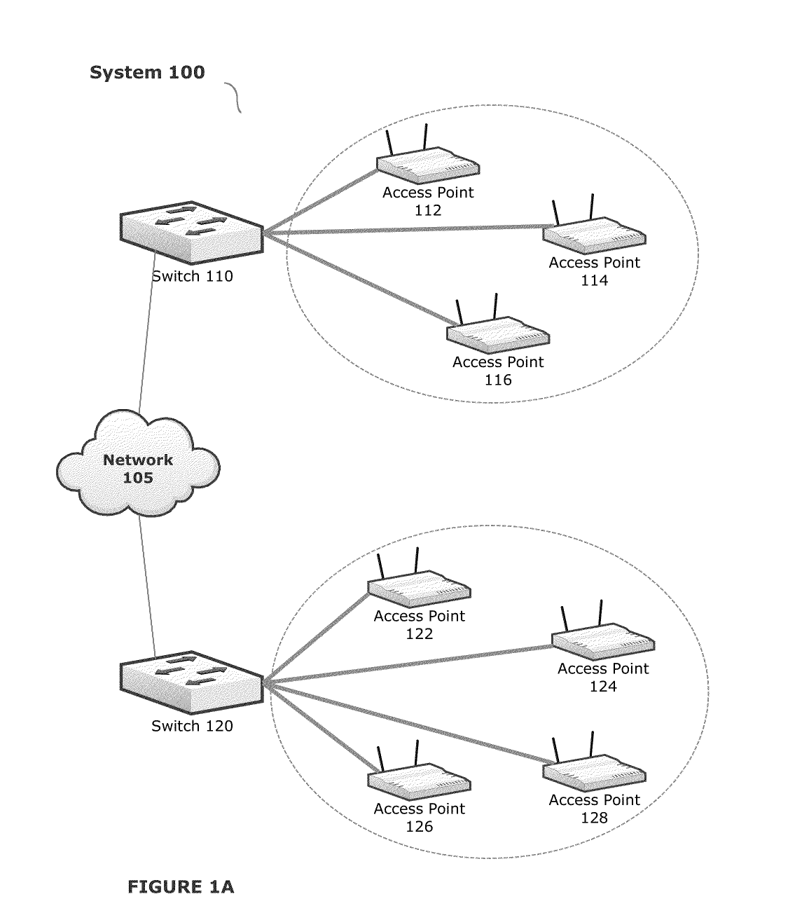

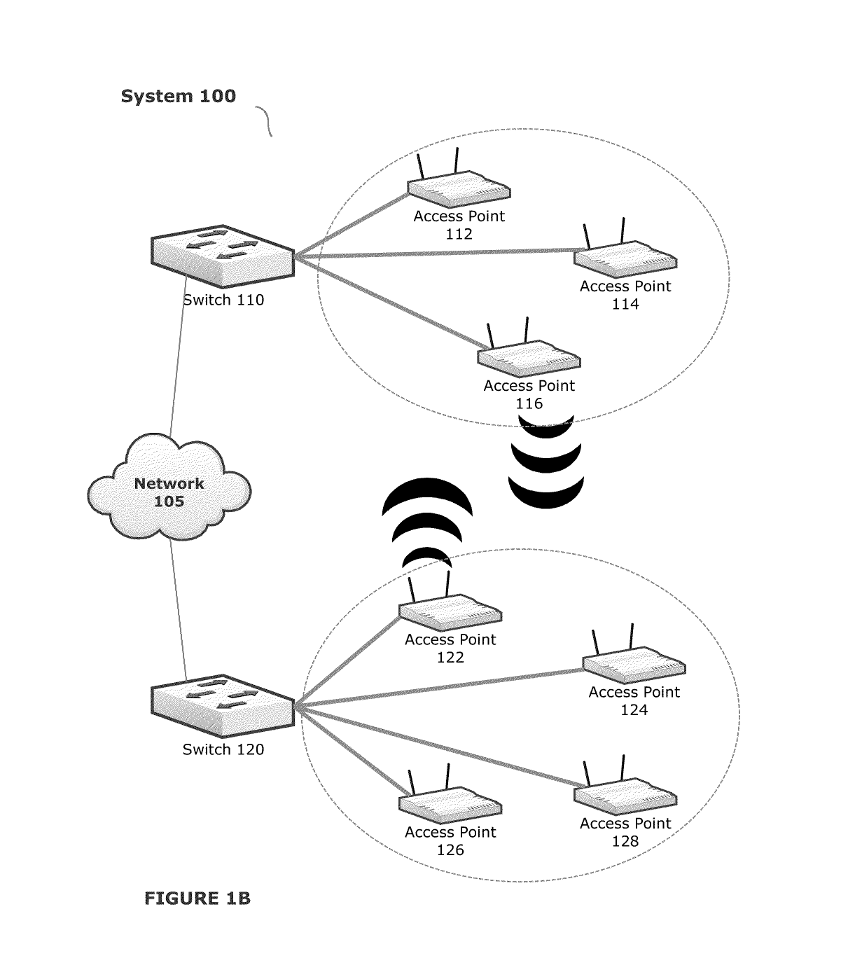

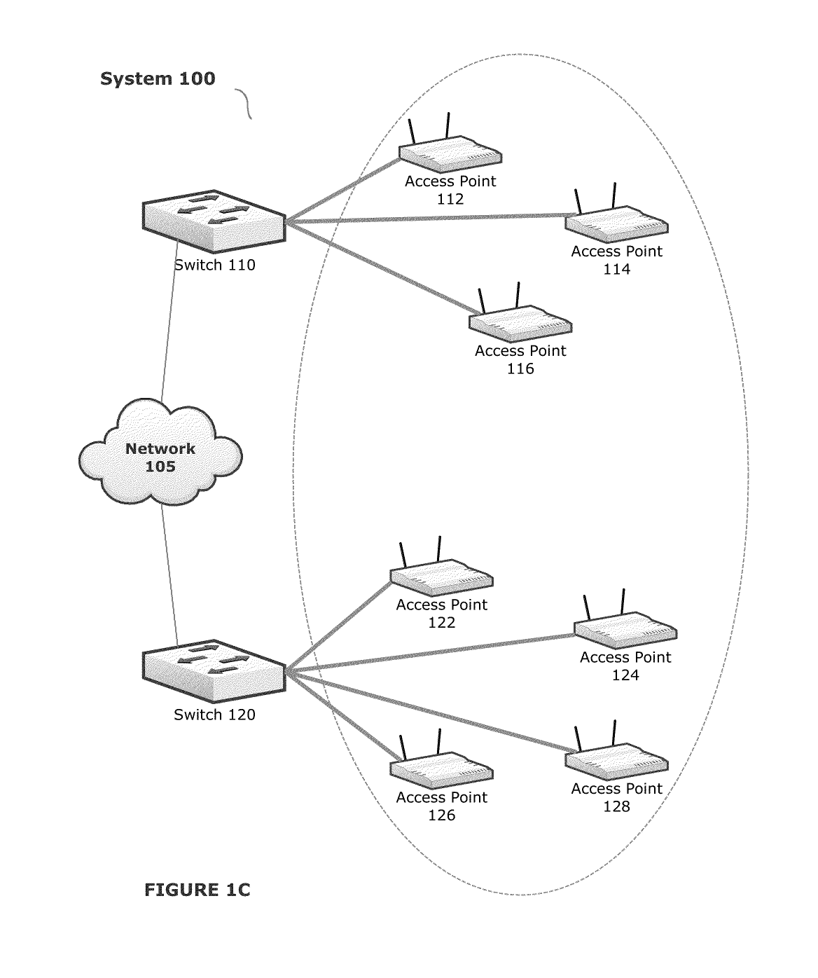

FIG. 1A illustrates a system 100 in accordance with one or more embodiments. The system 100 may be configured differently, may include more devices, or may include less devices than illustrated in FIG. 1. Furthermore, although access points are described and illustrated in examples herein, embodiments are applicable to any type of digital devices. Accordingly, the illustrations and examples herein should not be construed as limiting the scope of the disclosure.

In an embodiment, system 100 includes a first switch 110, a first set of digital devices (access point 112, access point 114, and access point 116), a second switch 120, and a second set of digital devices (access point 122, access point 124, access point 126, and access point 128). The first switch 110 and the second switch 120 are communicatively coupled via network 105. The first set of digital devices and the second set of digital devices is illustrated via respective dashed lines on FIG. 1A.

In an embodiment, the first set of digital devices is managed by a first virtual controller. Any of the first set of digital devices (access point 112, access point 114, and access point 116) or another digital device (not shown) can be implemented as the first virtual controller that manages the first set of digital devices. The implementation of the first virtual controller can be changed, for example, from access point 112 to access point 114. In one example, the first set of digital devices are communicatively coupled with switch 110 with a wired (or wireless) connection. The second set of digital devices may be managed by a second virtual controller and communicatively coupled with a switch 120 in a similar manner as the first set of digital devices described above.

In an embodiment, the first set of digital devices (for example, access point 112, access point 114, and access point 116) are implemented on a first IP subnet and the second set of digital devices are implemented on a second IP subnet, where the first IP subnet is different than the second IP subnet. In an embodiment, the second set of digital devices (for example, access point 122, access point 124, access point 126, and access point 128) on a second IP subnet select a second virtual controller for managing the second set of digital devices using a similar or different process than the process used by the first set of digital devices.

In an embodiment, one or more devices in the first set of digital devices managed using a first virtual controller discover, using wireless signals, one or more devices in the second set of digital devices managed using a second virtual controller (illustrated in FIG. 1B). Subsequent to the discovery, a single virtual controller is used to manage a merged group including both the first set and second set of digital devices (illustrated in FIG. 1C).

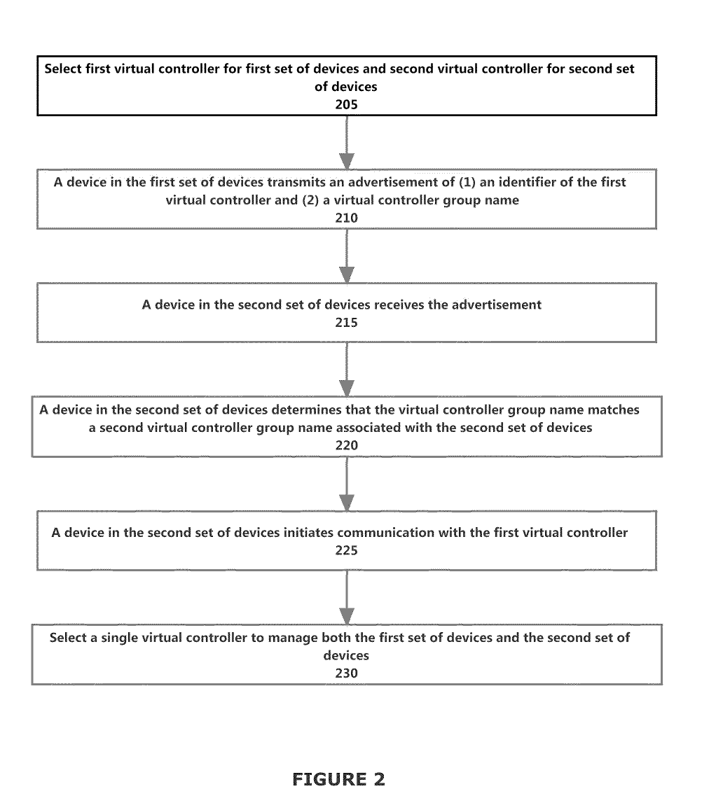

Although embodiments of the invention relate to any process for merging two or more sets of devices managed by respective virtual controllers, one example of such a process is described below with reference to FIG. 2.

Selecting a Virtual Controller for Managing Two or More Sets of Digital Devices Where Each Set of Digital Devices is Managed by a Respective Virtual Controller

FIG. 2 illustrates a method for selecting a virtual controller for managing two or more sets of digital devices where each set of digital devices is managed by a respective virtual controller. One or more operations illustrated in FIG. 4 may be modified, rearranged, or omitted all together. Accordingly, the particular sequence of operations illustrated in FIG. 2 should not be construed as limiting the scope of one or more embodiments.

Initially, a first virtual controller is selected for managing a first set of digital devices and a second virtual controller is selected for managing a second set of digital devices (Block 205). The selection of the virtual controller for managing a set of digital devices may be performed using an election process, assignment process, or other suitable process. In one example, a particular digital device in the first set of digital devices listens for announcements of virtual controllers on the first IP subnet for a period of time. If the particular digital device receives an announcement of a virtual controller from another device on the first IP subnet, then the particular digital device is configured to be managed by that virtual controller. If the particular digital device does not receive an announcement of a virtual controller from another device on the first IP subnet within the period of time, then the particular digital device announces the particular digital device (itself) as the virtual controller for devices on the first IP subnet. In this manner, a first virtual controller for managing the first set of digital devices on the first IP subnet may be selected. In another example, the assignment of a virtual controller for an IP subnet may be assigned by a device designated for selecting a virtual controller.

In one embodiment, a wireless signal is used for transmitting the announcement, of a virtual controller on the first IP subnet, from a particular member of the first IP subnet may be referred to herein as an advertisement. The wireless signal announcing a particular digital device as the virtual controller for the first IP subnet is broadcasted in a wireless signal in an encrypted message. Other members of that IP subnet which receive the wireless signal have a decryption key to decrypt the encrypted message and obtain the announcement of the virtual controller. An announcement of the virtual controller may also be transmitted using wired connections communicatively coupling devices in the first IP subnet(for example, via a switch or hub associated with the first IP subnet).

In an embodiment, at least one device, in the first set of digital devices that are managed by a first virtual controller, broadcasts an advertisement of one or more of: (1) an identifier for the first virtual controller and (2) a first virtual controller group name (Block 210). The advertisement may be secured (for example, via encryption) or unsecured. In an example, each digital device in the first set of digital devices is configured to transmit beacons with an Information Element that includes the Internet Protocol (IP) address of the first virtual controller and a virtual controller group name. The information element may be encrypted with a shared secret key known to access points that are configured for merging into a single virtual controller based group. Each device in the second set of digital devices may also transmit beacons with an Information Element that includes the Internet Protocol (IP) address of the second virtual controller and a second virtual controller group name associated with the second set of digital devices.

In one example, vendor specific information elements carry OSI Layer 3 information of a virtual controller for a virtual controller group. The OSI Layer 3 information may be encrypted with a secret shared key of the virtual controller group so devices within the same virtual controller group (devices intended to be within the same virtual controller group) can decrypt and use the information. Examples of message types which include virtual controller or virtual controller group information include beacons, association requests, re-association requests, probe request messages, and probe response messages.

The advertisement of an identifier of a first virtual controller and/or a first virtual controller group name that was transmitted by at least one device in the first set of digital devices is received by at least one device in the second set of digital devices (Block 215). In an example, a device in the second set of digital devices receives the advertisement in an encrypted form where both the IP address of the first virtual controller and the first virtual controller group name are encrypted. The receiving device (or other device in the second set of digital devices) then decrypts the encrypted first virtual controller group name using its shared key to obtain the first virtual controller group name (without encryption). The receiving device then compares the first virtual controller group name to a second virtual controller group name, the second virtual controller group name being the group name associated with the second set of digital devices.

In an embodiment, the receiving device (or other device in the second set of digital devices) determines that the first virtual controller group name matches the second virtual controller group name (Block 220). If the virtual controller group name associated with the first set of digital devices matches the second virtual controller group name associated with the second set of digital devices, then the first set of digital devices managed by the first virtual controller and the second set of digital devices managed by the second virtual controller are merged into a single set of digital devices by selecting a single virtual controller to manage both the first set of digital devices and the second set of digital devices. For example, an administrator may configure different digital devices with the same virtual controller group name such that when different groups of digital devices managed by different virtual controllers discover each other, the devices can automatically be merged for management by a single virtual controller based on the shared virtual controller group name. The match between the first virtual controller group name and the second virtual controller group name also indicates that the shared key, that was used for decrypting the first virtual controller group name, is correct. This verified shared key can then be used to decrypt the identifier (for example, IP address) of the first virtual controller. In an embodiment, at least a portion of the advertisement is not encrypted using a shared key. For example, the first virtual controller group name may be broadcasted in a non-encrypted and/or encrypted form while the identifier of the first virtual controller is broadcasted in an encrypted form. The encryption technique used for encrypting the parameters like Virtual Controller identifier and Virtual Controller Group Name with the shared secret may be an existing encryption standard or a proprietary one.

In an embodiment, a particular device in the second set of digital devices compares the identifier of a virtual controller in a received advertisement to an identifier of the second virtual controller that corresponds to the device. If the identifier in the received advertisement is different than the identifier of the second virtual controller, then the particular device determines that the virtual controller referred to in the advertisement is different than the second virtual controller and the operations recited in Block 225 are performed. If the identifier in the received advertisement is same as the identifier of the second virtual controller, then the process is ended. In this case, the process is ended as the advertisement is determined to be received from a digital device within the second set of digital devices (i.e., a device that is managed by the second virtual controller).

In an embodiment, a device in the second set of digital devices initiates communication with the first virtual controller (Block 225). In an example, device receiving the advertisement forwards at least the identifier of the first virtual controller to the second virtual controller. The second virtual controller then initiates communication with the first virtual controller based on the identifier of the first virtual controller. The communication between one or more of the first set of digital devices and one or more of the second set of digital devices is used to select a single virtual controller to manage both the first set of digital devices and the second set of digital devices (Block 230). In an example, the single virtual controller is selected from one of the first virtual controller and the second virtual controller based on a negotiation between the first virtual controller and the second virtual controller. In another example, another device, that is not one of the first virtual controller and the second virtual controller, is selected as the single virtual controller to manage both the first set of digital devices and the second set of digital devices.

In one embodiment, when a single virtual controller (different than the first virtual controller or the second virtual controller) is selected for managing both the first set of digital devices and the second set of digital devices, the first virtual controller and the second virtual controller cease to manage devices. In another embodiment, as indicated above, one of the first virtual controller and the second virtual controller is selected as the single virtual controller to manage the first set of digital devices and the second set of digital devices. In an embodiment, a vendor specific election mechanism is used to elect the single virtual controller.

In one example, access points on one floor of a business discover access points on another floor of the business by wireless communication between access points on different floors. The access points from the different floors determine that the access points are associated with the same business based on shared keys, virtual controller group names, or using other common information.

The above example methods describe selecting a single virtual controller for two different sets of digital devices for purposes of clarity. A single virtual controller can be selected for managing any number of sets of digital devices in accordance with one or more embodiments.

Selecting a Virtual Controller for Managing Two or More Sets of Digital Devices Where Each Set of Digital Devices is on a Separate IP Subnet

In an embodiment, the process described above is used for selecting a single virtual controller for digital devices on two different IP subnets. In general, devices on a single IP subnet select a virtual controller by transmitting signals on a wired connection that connects devices on that single IP subnet.

In one or more embodiments, wireless signals are used for selecting a virtual controller. The use of wireless signals allows devices on a first IP subnet to communicate with devices on a different second IP subnet and select a virtual controller for managing both the devices on the first IP subnet and the second IP subnet. In one example, devices on different IP subnets communicate via wireless signals to discover one another and after discovery, select a virtual controller to manage devices on different IP subnets. Any process for selecting a virtual controller after discovery via wireless signals may be used.

Extensions and Miscallaneous

One or more embodiments are directed to the discovery of virtual controller based access point groups using wireless signals. Devices that may be managed by a single virtual controller are often spread out over different IP subnets (for example, devices spread out in a large indoor or outdoor environment connected to a common organization or in case of highly mobile deployments where Access Points themselves are mobile and connected through Mesh links). The use of wireless signals for discovery of virtual controller based access point groups allow the devices over the different IP subnets to discover each other. The use of wireless signals for discovery of virtual controllers is advantageous over a wired discovery mechanism that uses a broadcast signal within a single IP subnet for announcements and discovery of a virtual controller.

One or more embodiments are directed to security features for use in discovery of access point groups via wireless signals. Security features such as encrypting at least a portion of beacon frames, which are typically encrypted, are advantageous to help limit the discovery and/or identification of virtual controller based access point groups to devices that have the decryption keys necessary for decrypting the portion of the beacon frames. An administrator may pre-configure certain devices to merge into a same virtual controller based access point group by pre-configuring the devices with the same virtual controller group name and/or the same shared key (when encryption is used).

One or more embodiments are directed to forming virtual controller based access point groups with devices across different IP subnets through the use of wireless signals (for example, Wi-Fi wireless signals or Bluetooth wireless signals). One or more embodiments are directed to merging different virtual controller based access point groups which is advantageous over conventional methods which (1) do not have a mechanism for one virtual controller based access point group to discover another virtual controller based access point group and (2) which do have a mechanism for merging different virtual controller based access point groups.

In an embodiment, virtual controller groups are formed based on virtual controller group names. Examples herein for forming virtual controller groups may be applicable to groups within a single IP subnet or different IP subnets. In one example, a first set of devices on a particular IP subnet are assigned a first virtual controller group name and a second set of devices on the same particular IP subnet are assigned a second virtual controller group name. Thereafter, only the devices that share the same virtual controller group name merge into a single virtual controller group to be managed by a respective virtual controller. Accordingly, in the example, two different virtual controller groups are formed from devices on the same IP subnet. In this example, the discovery of devices, the selection of the virtual controller groups, and/or the selection of the virtual controller for management of the virtual controller group may be performed using wired and/or wireless signals. Accordingly, embodiments of the invention are directed to the use of virtual controller group names to partition devices on a same IP subnet into different virtual controller groups to be managed by respective virtual controllers.

The present disclosure may be realized in hardware, software, or a combination of hardware and software. The present disclosure may be realized in a centralized fashion in one computer system or in a distributed fashion where different elements are spread across several interconnected computer systems coupled to a network. A typical combination of hardware and software may be an access point with a computer program that, when being loaded and executed, controls the device such that it carries out the methods described herein.

The present disclosure also may be embedded in non-transitory fashion in a computer-readable storage medium, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As used herein, “access point” (AP) generally refers to receiving points for any known or convenient wireless access technology which may later become known. Specifically, the term AP is not intended to be limited to IEEE 802.11-based APs. APs generally function to allow wireless devices to connect to a wired network via various communications standards.

As used herein, the term “mechanism” generally refers to a component of a system or device to serve one or more functions, including but not limited to, software components, electronic components, mechanical components, electro-mechanical components, etc.

As used herein, the term “embodiment” generally refers an embodiment that serves to illustrate by way of example but not limitation.

It will be appreciated to those skilled in the art that the preceding examples and embodiments are exemplary and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. The description is this to be regarded as illustrative rather than limiting.

What is claimed is:

1) One or more non-transitory computer readable storage mediums comprising instructions which, when executed by one or more hardware processors, cause performance of operations comprising:
receiving an advertisement in a wireless signal, the advertisement comprising an identification of a first virtual controller, the first virtual controller being configured for managing a first plurality of digital devices;
based at least on the advertisement, determining that the first plurality of digital devices is associated with a second plurality of digital devices managed by a second virtual controller;
responsive to determining that the first plurality of digital devices is associated with the second plurality of digital devices:
communicating, by at least one device in the second plurality of digital devices, with at least one device in the first plurality of digital devices.

2) The one or more computer readable storage mediums of claim 1, wherein the advertisement further comprises a first virtual controller group name associated with the first set of digital devices, and wherein determining that the first plurality of digital devices is associated with the second plurality of digital devices comprises determining that the first virtual controller group name matches a second virtual controller group name associated with the second plurality of digital devices.

3) The one or more computer readable storage mediums of claim 1, wherein the advertisement further comprises an encrypted first virtual controller group name associated with the first set of digital devices, and wherein the determining that the first plurality of digital devices is associated with the second plurality of digital devices comprises:
decrypting the encrypted first virtual controller group name in the advertisement to obtain a decrypted first virtual controller group name;
determining that the decrypted first virtual controller group name matches a second virtual controller group name associated with the second plurality of digital devices.

4) The one or more computer readable storage mediums of claim 1, wherein the identification of the first virtual controller is encrypted, and wherein the operations further comprise:
subsequent to receiving the advertisement, decrypting the identification of the first virtual controller using a shared key stored at each of the first plurality of digital devices and each of the second plurality of digital devices.

5) The one or more computer readable storage mediums of claim 1, wherein the first plurality of digital devices is on a first Internet Protocol (IP) subnet and wherein the second plurality of digital devices is on a second IP subnet that is different than the first IP subnet.

6) The one or more computer readable storage mediums of claim 1, wherein the operations further comprise:
transmitting, the identification of the first virtual controller, to the second virtual controller;
transmitting, by the second virtual controller to the first virtual controller using the identification of the first virtual controller, a message that initiates selection of a single virtual controller to manage both the first plurality of digital devices and the second plurality of digital devices.

7) One or more non-transitory computer readable storage mediums comprising instructions which, when executed by one or more hardware processors, cause performance of operations comprising:
managing, by a first virtual controller, a first plurality of digital devices;
managing, by a second virtual controller, a second plurality of digital devices;
selecting a particular virtual controller to manage both the first plurality of digital devices and the second plurality of digital devices;
subsequent to selecting the particular virtual controller: managing, by the particular virtual controller, both the first plurality of digital devices and the second plurality of digital devices.

8) The one or more computer readable storage mediums of claim 7, wherein the particular virtual controller is one of the first virtual controller and the second virtual controller.

9) The one or more computer readable storage mediums of claim 7, wherein the particular virtual controller is one of the first plurality of digital devices and the second plurality of digital devices.

10) The one or more computer readable storage mediums of claim 7, wherein the first plurality of digital devices is on a first Internet Protocol (IP) subnet and wherein the second plurality of digital devices is on a second IP subnet that is different than the first IP subnet.

11) The one or more computer readable storage mediums of claim 7, wherein each device in the first plurality of digital devices and the second plurality of digital devices is an access point.

12) The one or more computer readable storage mediums of claim 7, wherein the operations further comprise:
prior to selecting the particular virtual controller, determining that (a) one or more devices in the first plurality of digital devices and (b) one or more devices in the second plurality of digital devices are each associated with a same virtual controller group name.

13) The one or more computer readable storage mediums of claim 7, wherein the operations further comprise:
prior to selecting the particular virtual controller:
advertising, by a first digital device in the first plurality of digital devices, an identification of the first virtual controller.

14) One or more non-transitory computer readable storage mediums comprising instructions which, when executed by one or more hardware processors, cause performance of operations comprising:
receiving, by one or more wireless devices in a first plurality of wireless devices on a first Internet Protocol (IP) subnet, a wireless signal from one or more wireless devices in a second plurality of wireless devices on a second IP subnet that is different than the first IP subnet;
based at least on the wireless signal, selecting a single wireless device, from the first plurality of wireless devices or the second plurality of wireless devices, as a virtual controller for managing both the first plurality of wireless devices and the second plurality of wireless devices;
managing, by the virtual controller, the first plurality of wireless devices on the first IP subnet and the second plurality of wireless devices on the second IP subnet.

15) The one or more computer readable storage mediums of claim 13, wherein the virtual controller is implemented on a wireless device on the first IP subnet, and wherein the virtual controller manages the second plurality of wireless devices on the second IP subnet by transmitting wireless signals to at least one wireless device in the second plurality of wireless devices on the second IP subnet.

16) The one or more computer readable storage mediums of claim 13, wherein the virtual controller is implemented on a wireless device on the second IP subnet, and wherein the virtual controller manages the first plurality of wireless devices on the first IP subnet by transmitting wireless signals to at least one wireless device in the first plurality of wireless devices on the first IP subnet.

17) One or more non-transitory computer readable storage mediums comprising instructions which, when executed by one or more hardware processors, cause performance of operations comprising:
receiving, from a particular device, a beacon frame in accordance with IEEE 802.11 Standard;
wherein at least a portion of an Information Element (IE) in the beacon frame is encrypted, the portion comprising an advertisement;
decrypting at least the portion of the IE to obtain the advertisement;
determining information associated with the particular device based on the advertisement.

18) The one or more computer readable storage mediums of claim 16, wherein the beacon frame is periodically received from the particular device in a wireless signal, wherein the advertisement comprises identification of a virtual controller.
